(19) United States
(12) Patent Application Publication
(10) Pub. No.: US 2020/0400443 A1
(43) Pub. Date: Dec. 24, 2020

(54) SYSTEMS AND METHODS FOR LOCALIZATION

(71) Applicant: Direct Current Capital LLC, Wilmington, DE (US)

(72) Inventors: Joel PAZHAYAMPALLIL, Mountain View, CA (US); Sameep Tandon, Cupertino, CA (US)

(21) Appl. No.: 17/010,791

(22) Filed: Sep. 2, 2020

Related U.S. Application Data
(63) Continuation of application No. 16/020,905, filed on Jun. 27, 2018.
(60) Provisional application No. 62/525,725, filed on Jun. 27, 2017.

(51) Int. Cl. G01C 21/34; G06F 16/29; G06F 16/23; G05D 1/02; H04W 4/38; H04W 4/40; H04W 4/024; G01C 21/30; G01C 21/32

(52) U.S. Cl. CPC G01C 21/34; G06F 16/29; G06F 16/2379; G05D 1/0291; H04W 4/38; G05D 1/0088; H04W 4/024; G01C 21/30; G01C 21/32; G05D 2201/0213; H04W 4/40

(57) ABSTRACT

Systems and methods discussed herein involve localization of a device. In one implementation, a discrepancy flag associated with a particular geographic location is received from a device operating in a geographic region over a network. The discrepancy flag is generated based on a comparison of a local localization map of the device with scan data for a field of view of at least one sensor of the device. The scan data is received from the device over the network. A segment of a global localization map corresponding to the discrepancy flag is updated using the scan data. A plurality of vehicles operating in the geographic region is identified. The segment of the global localization map is selectively pushed to the plurality of devices based on a network connectivity of each of the plurality of devices and a location of each of the plurality of devices within the geographic region.

### CROSS-REFERENCE TO RELATED APPLICATIONS

The present application is a continuation of U.S. application Ser. No. 16/020,905, filed Jun. 27, 2018, which claims the benefit of U.S. Provisional Application No. 62/525,725, filed on Jun. 27, 2017. Each of these applications is incorporated in its entirety herein.

### TECHNICAL FIELD

The present disclosure relates generally to localization and navigation and more specifically to updating a global localization map based on detected changes along road surfaces.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method; and

FIG. 4 is a flowchart representation of one variation of the method.

The following description is not intended to limit the presently disclosed technology. Variations, configurations, implementations, and examples described herein are optional and are not exclusive. The presently disclosed technology described herein can include any and all permutations of these variations, configurations, implementations, and examples.

### DETAILED DESCRIPTION

### 1. Method

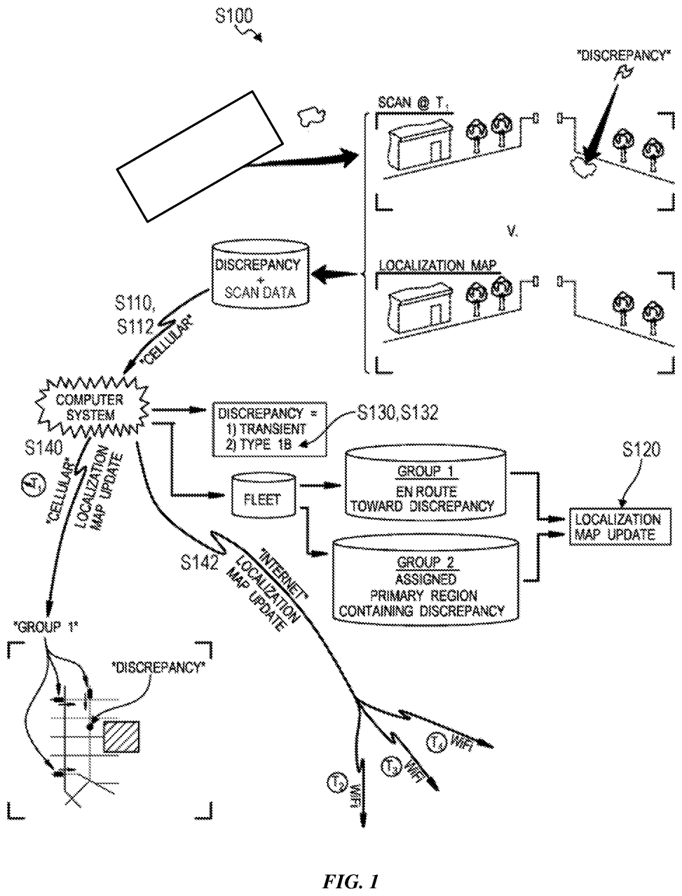

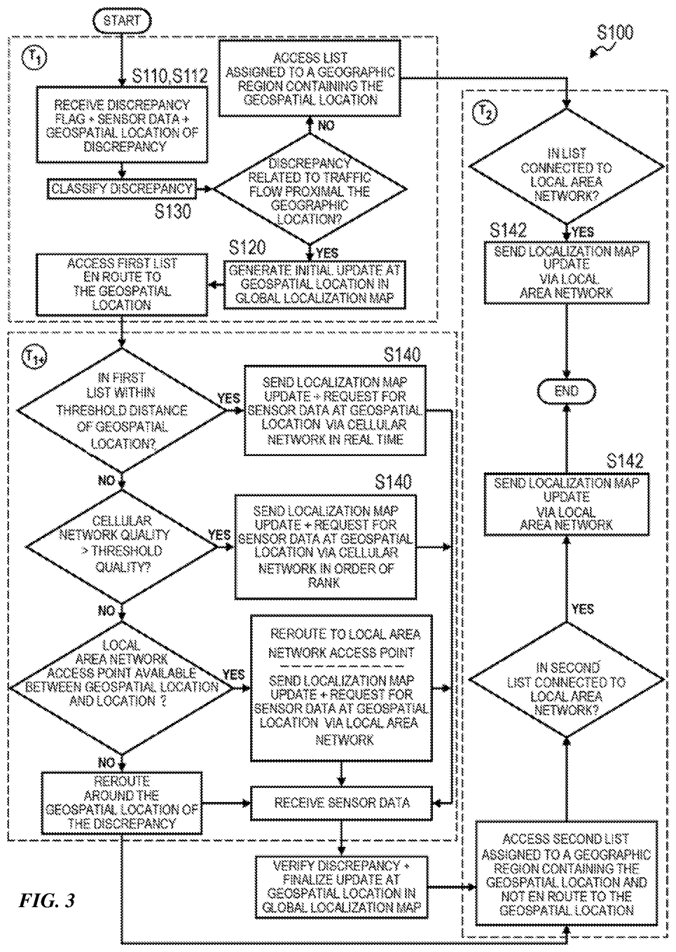

As shown in FIGS. 1 and 3, a method S100 for detecting and managing changes along road surfaces for autonomous vehicles includes: at approximately a first time, receiving a first discrepancy flag from a first vehicle via a low-bandwidth wireless network in Block S110, the first discrepancy flag indicating a first discrepancy between a particular feature detected proximal a first geospatial location at the first time by the first vehicle and a particular known immutable surface—proximal the first geospatial location—represented in a first localization map stored locally on the first vehicle; receiving sensor data, representing the first discrepancy, from the first vehicle at approximately the first time in Block S112; updating a first segment of a global localization map representing immutable surfaces proximal the first geospatial location based on the sensor data in Block S120; identifying a second vehicle currently executing a second route intersecting the first geospatial location in Block S140; at a second time approximating the first time, transmitting the first segment of the global localization map to the second vehicle, via the low-bandwidth wireless network, for incorporation into a second localization map stored locally on the second vehicle in Block S140; identifying a third vehicle operating within a geographic region containing the first geospatial location and executing a third route remote from the first geospatial location in Block S142; and, in response to the third vehicle connecting to a high-bandwidth computer network at a third time succeeding the first time, transmitting the first segment of the global localization map to the third vehicle, via the high-bandwidth computer network, for incorporation into a third localization map stored locally on the third vehicle in Block S142.

As shown in FIGS. 1 and 3, one variation of the method S100 includes: at approximately a first time, receiving a first discrepancy flag from a first vehicle via a wireless network in Block S110, the first discrepancy flag indicating a first discrepancy between a particular feature detected proximal a first geospatial location at the first time by the first vehicle and a particular known immutable surface—proximal the first geospatial location—represented in a first localization map stored locally on the first vehicle; receiving sensor data, representing the first discrepancy, from the first vehicle at approximately the first time in Block S112; updating a first segment of a global localization map representing immutable surfaces proximal the first geospatial location based on the sensor data in Block S120; identifying a second vehicle currently executing a second route intersecting the first geospatial location; and, at a second time approximating the first time, transmitting the first segment of the global localization map to the second vehicle, via the wireless network, for incorporation into a second localization map stored locally on the second vehicle in Block S140.

As shown in FIG. 1, another variation of the method S100 includes: receiving a discrepancy from a first vehicle over a low-bandwidth wireless network at a first time in Block S110, the first vehicle currently en-route and proximal a first location, and the discrepancy flag indicating a discrepancy between a surface detected at the first location and an expected surface defined in a first localization map stored locally at the first vehicle; receiving, from the first vehicle, sensor data related to the discrepancy flag in Block S112; generating an update to a global localization map based on the sensor data in Block S120; in response to receipt of the discrepancy flag, characterizing the discrepancy flag as one of a first discrepancy type associated with a change related to traffic flow proximal the first location in Block S130 and a second discrepancy type associated with a change unrelated to traffic flow proximal the first location in Block S132; transmitting the update to the second vehicle via the low-bandwidth wireless network at approximately the first time in Block S140 in response to characterizing the discrepancy flag as of the first discrepancy type and in response to the second vehicle approaching the first location; and, in response to characterizing the discrepancy flag as of the second discrepancy type, delaying transmission of the update to a third vehicle associated with a geographic region containing the first location in Block S142 until the third vehicle is connected to a high-bandwidth wireless network (or connected to a high-bandwidth wired connection, such as integrated into a charging plug connected to the vehicle when the vehicle is parked).

### 2. Applications

Generally, the method S100 can be executed by a computer system (e.g., a remote server, a computer network) in conjunction with road vehicles (e.g., an autonomous vehicle) operating within a geographic region to selectively update a global localization map with changes detected by these vehicles and to selectively push updates for the global localization map to these vehicles based on network connectivity of these vehicles and significance of such changes to immediate and longer-term operation of these vehicles within the geographic region. In particular, the computer system can develop and maintain a global localization map that represents georeferenced immutable surfaces on and near road surfaces within a geographic region, such as lane markers, traffic signs, road signs, traffic signals, crosswalks, road barriers, roadwork sites, trees, and building facades within this geographic region. The computer system can load all or a relevant segment of the global localization map onto each vehicle deployed in this geographic region, and each of these vehicles can: record an optical scan of its surrounding field with a set of integrated optical sensors; extract a constellation of features from this optical scan; calculate a geospatial location and attitude (or “pose”) of the vehicle that aligns this constellation of features to like immutable surfaces represented in a local copy of the localization map stored on the vehicle; and then immediately transmit a discrepancy flag and this optical scan to the computer system—such as via a local cellular network in (near) real-time—if the vehicle also detects a discrepancy (e.g., a change in position or orientation, or absence) between a feature in this constellation of features and the localization map. Upon receipt of a discrepancy flag and an optical scan from a vehicle operating in the geographic region in Blocks S110 and S112, the computer system can update a segment of the global localization map—corresponding to a particular location of the vehicle when the optical scan was recorded—to reflect this discrepancy (or “change”) based on this optical scan in Block S120. The computer system can then: identify a first subset of other vehicles currently near the particular location and/or currently executing routes that intersect this particular location; and push this segment of the global localization map to this first subset of vehicles in (near) real-time via a cellular network in Block S140, thereby preloading these vehicles en route to the location of these detected changes with “knowledge” of this change, enabling these vehicles to localize themselves within greater confidence near this location, and enabling these vehicles to elect and execute navigational actions through this location with greater confidence. Furthermore, the computer system can: identify a second subset of other vehicles deployed to this geographic region but not currently near the particular location or not currently executing routes that intersect this particular location; and push this segment of the global localization map to each vehicle in this second subset of vehicles asynchronously via a higher-bandwidth, lower cost computer network (e.g., the Internet) as these vehicles connect to this computer network over time in Block S142, such as via wired connections or via wireless local area network access points.

Therefore, in Blocks S110 and S112, the computer system can access sensor data—from a road vehicle in near real-time via a low-bandwidth wireless network (e.g., a cellular network)—indicating a (possible) discrepancy between a real surface detected by the vehicle in its surrounding field and a surface predicted at this location by a localization map stored on the vehicle. The computer system can then: update the global localization map to reflect this discrepancy in Block S120; characterize this discrepancy as related to traffic flow (e.g., obstacle avoidance, path planning) or localization of the vehicle via the localization map in Block S130; and then selectively distribute localization map updates to other vehicles in the geographic region based on the type of this discrepancy, perceived relevance of this discrepancy to operation of these other vehicles, and network connectivity of these other vehicles. For example, if the detected discrepancy is related to traffic flow (e.g., roadwork, a change in location of a crosswalk or crosswalk sign, an absent stop sign, absent or shifted lane markers) through a location proximal this discrepancy, the computer system can distribute a localization map update corresponding to this location to a first set of other vehicles moving toward this location via a relative high-cost, low-bandwidth wireless network (e.g., a cellular network) in near real-time, thereby enabling these vehicles to more rapidly detect, identify, and prepare to navigate around or through the detected discrepancy. In this example, the computer system can also asynchronously distribute this localization map update to a second set of other vehicles—known to traverse this location or otherwise deployed to a geographic region containing this location—via a less expensive, higher-bandwidth computer network as these vehicles connect to this computer network over time (e.g., when parked in a garage, when parked and recharging at a public charging station), thereby cost-effectively ensuring that localization maps stored on these vehicles remain up-to-date for the geographic regions in which these vehicles commonly operate.

### 2.1 Example

The computer system can interface with vehicles (hereinafter “autonomous vehicles”) that implement localization maps to determine their geospatial positions and orientations in real space while autonomously navigating along a planned route, such as defined in a separate navigation map. For example, an autonomous vehicle can: read a geospatial location from a geospatial position sensor integrated into the autonomous vehicle; select a region of a localization map—stored locally on the autonomous vehicle—containing georeferenced features near the geospatial location of the autonomous vehicle; record sensor data (e.g., color photographic images, RADAR data, ultrasonic data, and/or LIDAR data) through sensors integrated into the autonomous vehicle; extract features from these sensor data; calculate a transform that aligns features extracted from the sensor data to like georeferenced features represented in the selected region of the localization map; and then calculate its location and orientation in real space based on this transform (or otherwise based on the relative positions of real features detected in these sensor data and relative positions of like features represented in the localization map). The autonomous vehicle can then select or confirm its next action based on its determined location and orientation and the route currently assigned to the autonomous vehicle. In particular, the autonomous vehicle can implement computer vision and/or artificial intelligence techniques to autonomously elect navigational decisions, execute these navigational decisions, and autonomously navigate along a road surface; and the autonomous vehicle can implement a pre-generated localization map to determine its pose in real space and its position relative to typically-immutable objects—such as lane markers, road barriers, curbs, and traffic signs—in order to achieve higher-quality, high-confidence autonomous path planning, navigation, and interactions with other vehicles and pedestrians nearby.

However, such “immutable” features considered on and near road surfaces may change over time. For example: road accidents may occur and then be cleared within minutes or hours; roadwork equipment, signs, and barriers (e.g., cones, hard barriers) may be placed in roads during road construction for days or weeks, which may result in a permanent change to the road surface thereafter; road signs and trees along roads may be damaged, stolen, or replaced; and residential and commercial construction may change building geometries and facades facing road surfaces. While autonomously executing a route, an autonomous vehicle can compare a constellation of real features detected in its surrounding field to a constellation of georeferenced features represented in the localization map to determine its geospatial location and orientation. The autonomous vehicle may also detect discrepancies between this constellation of real features and the corresponding constellation of georeferenced features represented in the localization map, such as: transient discrepancies (e.g., other vehicles, pedestrians, traffic accidents, debris in the road surface); semi-permanent discrepancies (e.g., construction equipment, damaged barriers, damaged or missing road signs); and “permanent” (or “intransient”) discrepancies (e.g., modified lane markers, curbs, or crosswalks). The autonomous vehicle can then: flag certain transient, semi-permanent, and permanent discrepancies that may affect the autonomous vehicle's ability to localize itself and avoid collision with other vehicles and pedestrians; and communicate sensor data representing these discrepancies to the computer system in (near) real-time, such as via a cellular network. Upon receipt of such sensor data containing a flagged discrepancy detected by a first autonomous vehicle at a first geospatial location, the computer system can immediately push localization map updates representative of this discrepancy to a second autonomous vehicle traveling toward the first geospatial location, such as once the computer system has confirmed that this discrepancy may affect navigation, localization, and/or obstacle avoidance of the second autonomous vehicle when subsequently passing through the first geospatial location. However, the computer system can also asynchronously upload localization map updates for this discrepancy to a third autonomous vehicle not currently en route to the first geospatial location, such as when the third autonomous vehicle later connects to a “home” local area network access point (e.g., a Wi-Fi network in a residential garage or in a fleet parking garage or parking lot), since “knowledge” of this discrepancy at the first geospatial location may not immediately affect navigation, localization, and/or obstacle avoidance by the third autonomous vehicle. (Alternatively, the computer system can push this localization map update representing this discrepancy to the third autonomous vehicle at a later time via a lower-cost, lower-bandwidth cellular network when the third autonomous vehicle connects to this cellular network.)

The computer system can therefore execute Blocks of the method S100 in cooperation with a group or fleet of autonomous vehicles in order to selectively distribute localization map updates to these autonomous vehicles in (near-) real-time via a higher-cost/low(er)-bandwidth wireless network and asynchronously via a lower-cost/high(er)-bandwidth computer network based on types of discrepancies detected on and near road surfaces by autonomous vehicles in the fleet, based on proximity of other autonomous vehicles to locations of these detected discrepancies, based on scheduled routes assigned to these autonomous vehicles, and based on costs to communicate data to and from these autonomous vehicles over various networks.

The method S100 is described herein as executed in conjunction with a ground-based passenger, commercial, or fleet vehicle. However, Blocks of the method S100 can be executed by the computer system in conjunction with a vehicle of any other type.

### 3. Autonomous Vehicle

The method S100 can be executed by a computer system (e.g., a remote server) in conjunction with an autonomous vehicle. The autonomous vehicle can include: a suite of sensors configured to collect information about the autonomous vehicle's environment; local memory storing a navigation map defining a route for execution by the autonomous vehicle and a localization map that the autonomous vehicle implements to determine its location in real space; and a controller. The controller can: determine the location of the autonomous vehicle in real space based on sensor data collected from the suite of sensors and the localization map; determine the context of a scene around the autonomous vehicle based on these sensor data; elect a future navigational action (e.g., a navigational decision) based on the context of the scene around the autonomous vehicle, the real location of the autonomous vehicle, and the navigation map, such as by implementing a deep learning and/or artificial intelligence model; and control actuators within the vehicle (e.g., accelerator, brake, and steering actuators) according to elected navigation decisions.

In one implementation, the autonomous vehicle includes a set of 360° LIDAR sensors arranged on the autonomous vehicle, such as one LIDAR sensor arranged at the front of the autonomous vehicle and a second LIDAR sensor arranged at the rear of the autonomous vehicle or a cluster of LIDAR sensors arranged on the roof of the autonomous vehicle. Each LIDAR sensor can output one three-dimensional distance map (or depth image)—such as in the form of a 3D point cloud representing distances between the LIDAR sensor and external surface within the field of view of the LIDAR sensor—per rotation of the LIDAR sensor (i.e., once per scan cycle). The autonomous vehicle can additionally or alternatively include: a set of infrared emitters configured to project structured light into a field near the autonomous vehicle; a set of infrared detectors (e.g., infrared cameras); and a processor configured to transform images output by the infrared detector(s) into a depth map of the field.

The autonomous vehicle can also include one or more color cameras facing outwardly from the front, rear, and left lateral and right lateral sides of the autonomous vehicle. For example, each camera can output a video feed containing a sequence of digital photographic images (or “frames”), such as at a rate of 20 Hz. The autonomous vehicle can also include a set of infrared proximity sensors arranged along the perimeter of the base of the autonomous vehicle and configured to output signals corresponding to proximity of objects and pedestrians within one meter of the autonomous vehicle. The controller in the autonomous vehicle can thus fuse data streams from the LIDAR sensor(s), the color camera(s), and the proximity sensor(s), etc. into one optical scan of the field around the autonomous vehicle—such as in the form of a 3D color map or 3D point cloud of roads, sidewalks, vehicles, pedestrians, etc. in the field around the autonomous vehicle—per scan cycle. The autonomous vehicle can also collect data broadcast by other vehicles and/or static sensor systems nearby and can incorporate these data into an optical scan to determine a state and context of the scene around the vehicle and to elect subsequent actions.

The autonomous vehicle can also compare features extracted from this optical scan to like features represented in the localization map—stored in local memory on the autonomous vehicle—in order to determine its geospatial location and orientation in real space and then elect a future navigational action or other navigational decision accordingly.

However, the autonomous vehicle can include any other sensors and can implement any other scanning, signal processing, and autonomous navigation techniques to determine its geospatial position and orientation based on a local copy of a localization map and sensor data collected through these sensors.

### 4. Data Transfer Pathways

In Blocks S110, S140, and S142, the computer system can communicate with autonomous vehicles over various networks. For example, an autonomous vehicle can upload discrepancy flags and related sensor data to the computer system substantially in real-time via a cellular network in Block S110 when the autonomous vehicle detects a discrepancy between an immutable feature represented in a localization map stored on the autonomous vehicle and a real feature detected in (or absent) a corresponding geospatial location near the autonomous vehicle. In this example, once the computer system receives a discrepancy flag and sensor data representing this discrepancy from the autonomous vehicle, the system can: confirm that this discrepancy may affect navigation and collision avoidance of other autonomous vehicles passing through this geospatial location; identify a first set of autonomous vehicles currently executing routes that intersect this geospatial location; and selectively push a localization map update that reflects this discrepancy to this first set of autonomous vehicles in (near) real-time via the same cellular network, which may persist around this geospatial location. However, while cellular networks may exhibit handoff capabilities and network coverage that support real-time transfer of data between these autonomous vehicles and the computer system, cellular networks may provide limited bandwidth at a relatively high cost compared to a local area network (e.g., a WI-FI network connected to the Internet).

Therefore, once the computer system confirms that a discrepancy detected by an autonomous vehicle may affect navigation and collision avoidance of other autonomous vehicles passing through this geospatial location, the computer system can: identify a second set of autonomous vehicles operating within a geographic region containing the geospatial location but that are not currently scheduled to pass through or near this geospatial location; and selectively push a localization map update that reflects this discrepancy to this second set of autonomous vehicles via the Internet and local area networks, such as when these vehicles park at their “home” locations and are connected to home Wi-Fi networks at later times.

Alternatively, if the computer system determines that a discrepancy detected by an autonomous vehicle may marginally affect localization of autonomous vehicles near the location of this detected discrepancy—but not necessarily affect navigation or collision avoidance functions of these autonomous vehicles—the computer system can upload a localization map update representing this discrepancy to other autonomous vehicles deployed to this geographic region once these autonomous vehicles park and connect to local area networks.

While local area networks may exhibit minimal or no handoff capabilities or extended long-distance network coverage, local area networks may exhibit relatively high-bandwidth at relatively low cost compared to a cellular network. The computer system can therefore leverage an autonomous vehicle's connection to a local area network to load a localization map update that is not time sensitive onto this autonomous vehicle when the autonomous vehicle connects to this local area network over time, thereby limiting cost to maintain an updated localization map on the autonomous vehicle.

Furthermore, upon detecting a discrepancy between an optical scan and a local copy of the localization map, an autonomous vehicle can compress this optical scan and then upload this compressed optical scan to the computer system via a local cellular network, thereby limiting latency and cost to serve these sensor data to the computer system. However, once the autonomous vehicle is parked and connected to a local area network, the autonomous vehicle can upload this optical scan in an uncompressed (or “raw”) format to the computer system via the local area network in order to limit cost of access to more complete sensor data representing this discrepancy.

### 5. Maps and Autonomous Navigation

As described above, an autonomous vehicle can be loaded with a navigation map that defines paths for navigating along roads from a start or current location to a destination, such as specified by a passenger. For example, the navigation map can define a route from a current location of the autonomous vehicle to a destination entered by a user, such as calculated remotely by the computer system, and can include roadways, waypoints, and geospatial markers along this route. The autonomous vehicle can autonomously follow the route defined in the navigation map and then discard the navigation map at the conclusion of the route.

The autonomous vehicle can also be loaded with a localization map that represents real features on and near road surfaces within a geographic region. In one implementation, a localization map defines a 3D point cloud (e.g., a sparse 3D point cloud) of road surfaces and nearby surfaces within a geographic region. In another implementation, the localization map includes a heightmap or heightfield, wherein the (x,y) position of each pixel in the heightmap defines a lateral and longitudinal (geospatial) position of a point on a real surface in real space, and wherein the color of each pixel defines the height of the corresponding point on the real surface in real space, such as relative to a local ground level. In yet another implementation, the localization map defines a multi-layer map including layers (or “feature spaces”) representing features in real space, wherein features in these layers are tagged with geolocations. In this implementation, the localization map can include one feature space for each of various discrete object types, such as a road surface, lane markers, curbs, traffic signals, road signs, trees, etc.; and each feature contained in a metaspace can be tagged with various metadata, such as color, latitude, longitude, orientation, etc. In this implementation, the autonomous vehicle can also be loaded with feature models, and the autonomous vehicle can implement these feature models to correlate sensor data collected during operation with objects represented in layers of the localization map.

During execution of a route defined in a navigation map, an autonomous vehicle can record scans of its environment through sensors integrated into the autonomous vehicle, such as through one or more cameras, RADAR sensors, and/or LIDAR sensors and such as at a rate of 100 Hz. The autonomous vehicle can then: implement computer vision techniques and the feature models to associate groups of points and/or surfaces represented in a scan with types, characteristics, locations, and orientations of features in the field around the autonomous vehicle at the time of the scan; project locations and orientations of these features onto the localization map—which contains georeferenced representations of these features—to determine the real location and orientation of the vehicle in real space at the time of the scan. In particular, rather than rely solely on data from a geospatial position sensor in the autonomous vehicle to determine its location in real space, the autonomous vehicle can derive its location in real space by: detecting real features (e.g., objects, surfaces) within a field around the autonomous vehicle; matching these real features to features represented in the localization map; and calculating a geolocation and orientation of the autonomous vehicle that aligns real features detected in the field around the autonomous vehicle and to like features represented in the localization map, which may enable the autonomous vehicle to determine and track is geospatial location with greater accuracy and repeatability.

The autonomous vehicle can then elect its next navigational action based on its derived geospatial location and orientation. For example, the autonomous vehicle can determine whether to: brake as the autonomous vehicle approaches a stop sign or yield sign indicated in the navigation or localization map; or begin turning to follow its assigned route. In another example, the autonomous vehicle can: detect its position within a lane in its immediate vicinity based on positions of lane markers detected in optical scans recorded by the autonomous vehicle; extrapolate its trajectory relative to this lane at greater distances (e.g., greater than ten meters) ahead of the autonomous vehicle based on its derived geospatial location and georeferenced features representing lane markers on this segment of road in the localization map; and then autonomously adjust its steering position in order to maintain its position centered within its current lane. Similarly, the autonomous vehicle can: preemptively prepare to navigate around fixed obstacles—such as roadwork, road barriers, and curbs—represented in the localization map (or in the navigation map) based on the derived geospatial location of the autonomous vehicle and the route currently executed by the autonomous vehicle, such as before detecting these fixed obstacles in the sensor data recorded by sensors in the autonomous vehicle; autonomously adjust its trajectory accordingly; and confirm presence of these fixed obstacles and its path around these fixed obstacles as these fixed obstacles come into view of the autonomous vehicle.

The autonomous vehicle can therefore leverage the localization map and sensor data recorded by the autonomous vehicle to derive its geospatial location, to track its progress along a route, and to make navigational adjustments based on upcoming obstacles and features on the road surface even before sensing these obstacles and features. The autonomous vehicle can also process these sensor data to detect, identify, and track mutable (i.e., mobile) objects within the field around the autonomous vehicle and to control brake, accelerator, and steering actuators within the autonomous vehicle to avoid collision with these mutable objects while navigating its assigned route.

However, the autonomous vehicle can implement any other methods or techniques to select and execute navigational actions based on sensor data, a segment of a global localization map stored in local memory on the autonomous vehicle, and a navigation map of a geographic region in which the autonomous vehicle is deployed.

### 6. Preloaded Localization Map

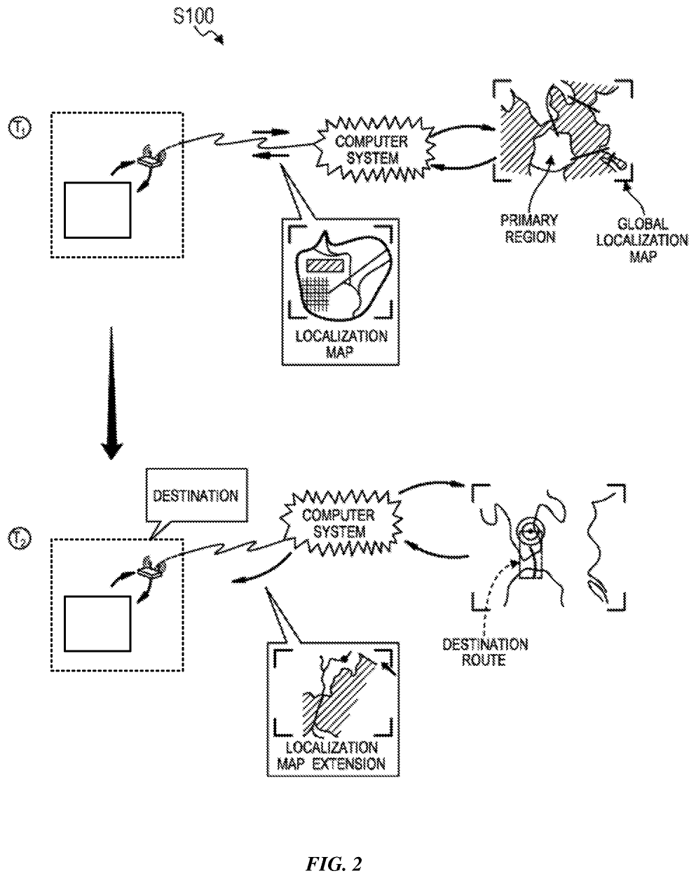

As shown in FIG. 2, the computer system can maintain a global localization map containing features that represent road surfaces, lane markers, barriers, buildings, street signs, traffic lights, light posts, and/or other (approximately, typically) immutable objects within and around navigable roads within a geographic region (e.g., a city, a state, a country, or a continent). The computer system can also: deploy a new autonomous vehicle to this geographic region; and authorize the autonomous vehicle to operate autonomously within a segment of this geographic region (e.g., a “primary geographic region”) including a “home” location designated for the autonomous vehicle. For example, the computer system can interface with an owner or operator of the autonomous vehicle via an operator portal executing on a computing device to define the primary geographic region to the autonomous vehicle, including: a town, a city, or an area code; a polygonal land area defined by a set of georeferenced vertices; or a 25-mile radius around the autonomous vehicle's designated “home” location (e.g., a private residence, a parking space within a private community, a garage on a business or educational campus, a fleet garage).

Once the computer system assigns this primary geographic region to the autonomous vehicle, the computer system can extract a localization map from a region of the global localization map corresponding to the primary geographic region assigned to the autonomous vehicle and then transmit this localization map to the autonomous vehicle, such as via the Internet when the autonomous vehicle is parked at its designated “home” location and connected to a wireless local area network access point. Therefore, the computer system can: assign a primary geographic region to an autonomous vehicle; extract a localization map—representing immutable surfaces proximal road surfaces within this primary geographic region—from the global localization map; upload this localization map to the autonomous vehicle via a high-bandwidth computer network; and then authorize this autonomous vehicle to autonomously navigate within the primary geographic region once the localization map is loaded onto the autonomous vehicle. However, the computer system can implement any other method or technique to assign a primary geographic region to the autonomous vehicle.

Subsequently, while the autonomous vehicle operates within its assigned primary geographic region, the autonomous vehicle can implement this localization map to determine its real geospatial location and orientation, as described above. The computer system can also implement methods and techniques described herein to push localization map updates to the autonomous vehicle responsive to discrepancies detected by other vehicles operating within the primary geographic region over time.

Furthermore, when the autonomous vehicle is assigned a route or destination that falls outside of the primary geographic region thus assigned to the autonomous vehicle, the computer system can: calculate a secondary geographic region containing this route or destination; extract a localization map extension corresponding to the secondary geographic region from the global localization map; and upload this localization map extension to the autonomous vehicle for combination with the (primary) localization map currently stored in local memory on the autonomous vehicle, as shown in FIG. 2. The autonomous vehicle can thus store—in local memory—a localization map corresponding to a primary geographic region assigned to the autonomous vehicle and localization map extensions that extend this localization map to include new routes and/or destinations beyond the primary geographic region. The autonomous vehicle can then implement this updated localization map to determine its geospatial location and orientation in real space when navigating to destinations beyond its original primary geographic region.

The computer system can therefore selectively push localization map extensions to the autonomous vehicle over time. The computer system can also implement methods and techniques described below to selectively push localization map updates for the localization map extensions to the autonomous vehicle over time, such as in (near) real-time when the autonomous vehicle is executing a route that extends beyond the primary geographic region originally assigned to the autonomous vehicle.

### 7. Detecting Discrepancies

During execution of a route defined by a navigation map, an autonomous vehicle can isolate discrepancies (or “changes,” “differences”) between types, locations, and/or orientations of features detected in the field around the autonomous vehicle and types, locations, and/or orientations of features represented in a localization map stored locally on the autonomous vehicle, as shown in FIG. 1. For example, the autonomous vehicle can: collect sensor data through sensors integrated into the vehicle; characterize features detected in these sensor data with feature types (e.g., lane markers, road signs, curbs, building facades, other vehicles, pedestrians, rain or puddles, road debris, construction cones, road barriers) based on feature models described above; and isolate a subset of these features that correspond to immutable feature types (e.g., lane markers, road signs, curbs, building facades, road barriers). The autonomous vehicle can then match this subset of detected features—labeled as immutable feature types—to “ground truth” immutable features represented in the localization map; and determine its geospatial location and orientation based on a transform that aligns this constellation of features to corresponding ground truth features in the localization map with minimal error. However, in this example, the autonomous vehicle can also scan this constellation of detected features to corresponding ground truth features in the localization map for discrepancies, such as: a detected feature labeled as immutable by the autonomous vehicle but not represented in the corresponding location in the localization map; a ground truth feature represented in the localization map and labeled as immutable but not detected in a corresponding location in the field around the autonomous vehicle; a detected feature classified as a first feature type at a location of a ground truth feature classified as a second feature type in the localization map; or a detected feature matched to a ground truth feature in the localization map but located at locations or orientations differing by more than localization error of the autonomous vehicle, such as shown in FIG. 1.

Therefore, the autonomous vehicle can: record an optical scan of a field around the autonomous vehicle through a suite of optical sensors arranged on the autonomous vehicle; extract features from the optical scan; isolate a set of features corresponding to immutable objects in the field around the autonomous vehicle; determine its geospatial location at this time based on a transform that aligns a subset of features—in this set of features—with corresponding immutable surfaces represented in the localization map stored on the autonomous vehicle; and isolate a particular feature—in the first set of features—that differs from a particular known immutable surface represented in a corresponding location in the localization map. Then, in response to isolating this particular feature that corresponds to an immutable object in the field around the autonomous vehicle and differs from a corresponding known immutable surface represented in the localization map, the autonomous vehicle can transmit a discrepancy flag for this discrepancy and the optical scan—in raw or compressed format—to the computer system via a local low-bandwidth wireless network (e.g., a cellular network) in (near) real-time.

### 7.1 Selective Discrepancy Upload

In one implementation, the autonomous vehicle can also: selectively upload a discrepancy flag and corresponding sensor data to the computer system in (near) real-time via a low-bandwidth wireless network (e.g., a cellular network) if the discrepancy affects traffic flow nearby; and otherwise delay transmission of the discrepancy flag and corresponding sensor data to the computer system via a high-bandwidth computer network when the autonomous vehicle connects to this high-bandwidth computer network at a later time. For example, the autonomous vehicle can selectively upload a discrepancy flag and corresponding sensor data to the computer system in (near) real-time via a local cellular network if the discrepancy corresponds to a change in geospatial position, to absence or to presence of a road sign, a traffic signal, a lane marker, a crosswalk, a roadwork site, or a road barrier in the field around the autonomous vehicle. Once the autonomous vehicle first detects a discrepancy of this type (e.g., “Type 1B” and “Type 1C” discrepancies described below) in a first optical scan of its surrounding field, as described above, the autonomous vehicle can: initiate a connection to the computer system via a local cellular network; upload the first optical scan to the computer system via the cellular network; regularly record additional optical scans, such as at a rate of 10 Hz; track and flag this discrepancy in these subsequent optical scans; and stream these optical scans to the computer system via the cellular network until the source of the discrepancy is no longer in the field of view of the autonomous vehicle or is represented at less than a threshold resolution in these optical scans.

Alternatively, in the foregoing example, the autonomous vehicle can generate a discrepancy flag corresponding to a change in geospatial position, to absence, or to presence of a tree, a building façade, a parked vehicle proximal, or other object unrelated to or otherwise minimally affecting traffic flow near the field around the autonomous vehicle. In response to detecting a discrepancy of this type (e.g., a “Type 1A” discrepancy described below), the autonomous vehicle can: record this discrepancy in a sequence of optical scans recorded by the autonomous vehicle while traversing a geospatial location past this discrepancy; and transmit this discrepancy flag and the sequence of optical scans corresponding to this discrepancy to the remote computer system via the high-bandwidth computer network at a later time, such as in response to the autonomous vehicle wirelessly connecting to a high-bandwidth wireless local area network access point located in a “home” location assigned to the autonomous vehicle or when the autonomous vehicle parks in a refueling or recharging station at a later time.

Therefore, in the foregoing implementation, the autonomous vehicle can: record an optical scan of the field around the autonomous vehicle; extract a set of features from the optical scan; determine a geospatial location of the autonomous vehicle at this time based on a transform that aligns a subset of features in the set of features with corresponding immutable surfaces represented in the localization map stored locally on the autonomous vehicle; isolate a feature—in the set of features—that differs from a known immutable surface represented in the first localization map; generate a discrepancy flag in response to the known immutable surface being unrelated to traffic flow (e.g., corresponding to one of a tree, a building façade, or presence of a parked vehicle proximal in a parking lane); and then transmit the discrepancy flag and the optical scan to the remote computer system via the high-bandwidth computer network at a later time in response to the autonomous vehicle wirelessly connecting to a high-bandwidth wireless local area network access point. The computer system can then implement methods and techniques described below to update the global localization map to reflect this discrepancy and to asynchronously distribute a localization map update to other autonomous vehicles in the geographic region, such as when these autonomous vehicles connect to high bandwidth local area networks over a subsequent period of time.

### 7.2 Type 0 and Type 1 Discrepancies

In another implementation, once the autonomous vehicle detects a discrepancy, the autonomous vehicle can classify the discrepancy based on whether the discrepancy corresponds to a mutable or immutable object and whether the discrepancy affects autonomous navigation of the autonomous vehicle. For example, the autonomous vehicle can label common discrepancies corresponding to a mutable object as “Type 0” discrepancies, such as if the discrepancy corresponds to a vehicle moving in a vehicle lane, a parked vehicle in a parking lane or parking lot, or a pedestrian occupying a sidewalk or a crosswalk indicated in the localization map. However, if the discrepancy corresponds to an object specified as immutable by the localization map—such as a lane marker, a road barrier, a road surface, a road sign, or a building façade—the autonomous vehicle can label this discrepancy as a “Type 1” discrepancy. For example, the autonomous vehicle can label discrepancies that do not require the autonomous vehicle to deviate from its planned trajectory—such as a change in foliage, a change in a building façade, or a change in a road sign in the autonomous vehicle's field—as “Type 1A” discrepancies. Upon detecting a Type 1A discrepancy, the autonomous vehicle can generate a georeferenced Type 1A discrepancy flag specifying the type and location of this detected discrepancy.

Similarly, in the foregoing implementation, the autonomous vehicle can label a discrepancy that prompts the autonomous vehicle to modify its planned trajectory—such as by moving into a different lane from that specified in the navigation map—as a “Type 1B” discrepancy. For example, the autonomous vehicle can label changes in lane markers, presence of construction cones or road construction equipment, presence of a minor accident, or a vehicle parked in a shoulder or median on a highway as a Type 1B discrepancy. Upon detecting a Type 1B discrepancy, the autonomous vehicle can generate a georeferenced Type 1B discrepancy flag with metadata containing compressed sensor data representing the discrepancy in real space. Alternatively, the autonomous vehicle can assemble the Type 1B discrepancy flag with raw sensor data from a limited number of scans completed by the autonomous vehicle—such as one scan recorded 10 meters ahead of the location of the discrepancy, one scan recorded as the autonomous vehicle passes the location of the discrepancy, and one scan recorded 10 meters behind the location of the discrepancy.

Furthermore, the autonomous vehicle can label a discrepancy that triggers the autonomous vehicle to cease autonomous execution of its planned trajectory as a “Type 1C” discrepancy. For example, responsive to detecting a Type 1C discrepancy, the autonomous vehicle can: autonomously pull over to a stop in a road shoulder; prompt an occupant to assume full manual control of the autonomous vehicle and to then transition into manual mode until the location of the detected discrepancy is passed; or transmit a request to a tele-operator to remotely control the autonomous vehicle past the location of the Type 1C discrepancy. Upon detecting a Type 1C discrepancy, the autonomous vehicle can label optical scans of the field around the autonomous vehicle coincident this discrepancy with georeferenced Type 1C discrepancy flags, as described above. For example, the autonomous vehicle can: label presence of a large accident (e.g., a multi-car pile-up, an overturned truck) or presence of a foreign, unknown object (e.g., a mattress) blocking a road surface ahead of the autonomous vehicle as a Type 1C discrepancy; and then generate a georeferenced Type 1C discrepancy flag with metadata containing raw sensor data collected as the autonomous vehicle approaches and/or passes the geospatial location of this discrepancy.

The autonomous vehicle can therefore: generate a discrepancy flag in response to detecting a Type 1 discrepancy (or a discrepancy of any other type or magnitude); tag the discrepancy flag with its geolocation; and link the discrepancy flag to select metadata, compressed sensor data, and/or raw sensor data and at a density corresponding to the type or severity of the discrepancy. For Type 1 A discrepancies, the autonomous vehicle can: push discrepancy flags to the computer system substantially over a low-bandwidth wireless network in real-time and push related sensor data to the computer system over a high-bandwidth computer network once the autonomous vehicle connects to this computer network at a later time (e.g., when later parked at a “home” location). However, the autonomous vehicle can: push discrepancy flags and related compressed sensor data for Type 1B discrepancies to the computer system over the low-bandwidth wireless network substantially in real-time; and similarly push discrepancy flags and related raw or high(er)-resolution sensor data for Type 1C discrepancies to the computer system over the low-bandwidth wireless network substantially in real-time.

Alternatively, in the foregoing implementations, the autonomous vehicle can: push discrepancy flags to the computer system substantially in real-time over the low-bandwidth wireless network; and then return corresponding raw or compressed sensor data to the computer system over the low-bandwidth wireless network or the high-bandwidth computer network once requested by the computer system, as described below. However, the autonomous vehicle can implement any other method or technique to characterize a discrepancy detected in its surrounding field and to selectively upload a discrepancy flag and related sensor data to the computer system.

### 8. Data Collection

Block S110 of the method recites receiving a first discrepancy flag from a first vehicle via a low-bandwidth wireless network; and Block S112 of the method S100 recites receiving sensor data, representing the first discrepancy, from the first vehicle at approximately the first time. Generally, in Blocks S110 and S112, the computer system collects discrepancy flags and related sensor data from one or more autonomous vehicles traversing routes past a detected discrepancy and confirms this detected discrepancy based on these data before updating the global localization map and pushing localization map updates to autonomous vehicles deployed in this geographic region, as shown in FIGS. 1 and 3.

### 8.1 Sensor Data from a Single Vehicle

In one implementation, after detecting a discrepancy in an optical scan recorded at a particular geospatial location, the autonomous vehicle can: continue to record optical scans of the field around the autonomous vehicle; detect the discrepancy in these subsequent optical scans; and transmit (or “stream”) these optical scans and discrepancy flags to the computer system in (near) real-time via a local cellular network until the autonomous vehicle moves out of sensible (e.g., visual) range of the discrepancy or until the computer system returns confirmation—via the local cellular network—that the discrepancy has been sufficiently modeled or verified. As the computer system receives these sensor data from the autonomous vehicle in (near) real-time, the computer system can compile this stream of sensor data received from the autonomous vehicle into a 3D representation of the field around the autonomous vehicle—including the discrepancy detected by the autonomous vehicle—and compare this 3D representation of the field to the global localization map to isolate and verify the discrepancy. The autonomous vehicle can then selectively distribute a localization map representing this discrepancy to other autonomous vehicles in the geographic region accordingly, as described below.

### 8.2 Sensor Data from Multiple Vehicles

The computer system can also aggregate discrepancy flags and sensor data received from many autonomous vehicles operating within a geographic region over time and group these detected discrepancies by geospatial proximity. For a group of discrepancy flags received from multiple autonomous vehicles and falling within close proximity (e.g., within one meter at a distance of ten meters from an autonomous vehicle), the computer system can then: aggregate sensor data paired with these discrepancy flags, such as time series of optical scans recorded by autonomous vehicle navigating past the discrepancy over a period of time after the discrepancy was first detected (e.g., within the first hour of detection of the discrepancy, a first set of ten distinct traversals past the discrepancy by autonomous vehicles in the field); characterize or model the field around and including this discrepancy based on these sensor data; and then update a small segment of the global localization map around the geospatial location of this discrepancy accordingly.

As described above, an autonomous vehicle can upload a discrepancy flag and related sensor data (e.g., metadata, compressed sensor data, and/or raw sensor data, based on the type of the discrepancy) to the computer system over the low-bandwidth wireless network substantially immediately after first detecting a discrepancy. After receiving the discrepancy flag and sensor data from the autonomous vehicle, the computer system can: initially confirm the discrepancy based on these sensor data, such as described above; upload a localization map update to a select subset of autonomous vehicles currently en route to the location of the discrepancy, as described below; transmit a request to this subset of autonomous vehicles for sensor data recorded while traversing the geospatial location of the discrepancy; and then further refine the global localization map to reflect this discrepancy based on these additional sensor data received from these other autonomous vehicles. More specifically, these additional sensor data may depict the discrepancy from different perspectives, and the computer system can leverage these additional sensor data to converge on a more complete representation of the discrepancy in the global localization map.

For example, the computer system can: prompt autonomous vehicles executing routes past the geospatial location of this discrepancy to record and return optical scans to the computer system, such as in real-time or upon connecting to a local area network at a later time; refine the update for the global localization map based on these sensor data, as shown in FIG. 3; and then deactivate collection of additional data at this geospatial location once the computer system converges on a localization map update that reflects this discrepancy.

In a similar example shown in FIG. 3, after a first autonomous vehicle detects a discrepancy at a first geospatial location at a first time, the computer system can generate an initial localization map update (i.e., a segment of the global localization map) reflecting this discrepancy based on a first optical scan and discrepancy flag received from the first autonomous vehicle and push this initial localization map to a second autonomous vehicle approaching this first geospatial location. The second autonomous vehicle can then: load this initial localization map update into a second localization map stored in local memory on the second autonomous vehicle; record a second optical scan of a field around the second vehicle when traveling past the first geospatial location at a second time; extract a second set of features from the second optical scan; determine its geospatial location of the second vehicle at the second time based on a second transform that aligns a subset of features in the second set of features with corresponding immutable surfaces represented in the initial localization map update thus incorporated into the second localization map. In this example, the second autonomous vehicle can return this optical scan to the computer system, and the computer system can: confirm the discrepancy proximal the first geospatial location based on features detected in the second optical image (e.g., if all features detected in the second optical image match corresponding immutable surfaces represented in the initial localization map update); finalize the localization map update after thus confirming the discrepancy; and then distribute this localization map update to other autonomous vehicles deployed in this geographic region, as described below.

The computer system can also clear a discrepancy at a geospatial location if other autonomous vehicles passing the geospatial location of the discrepancy—detected by one autonomous vehicle—fail to return like discrepancy flags or if sensor data requested from these other autonomous vehicles by the computer system fail to reflect this discrepancy. The computer system can therefore continue to reevaluate a discrepancy at a particular geospatial location as additional autonomous vehicles pass this geospatial location and return sensor data to the computer system.

In this implementation, the computer system can also verify a type of the discrepancy—such as whether the discrepancy is a Type 1A, 1B, or 1C discrepancy—based on discrepancy types and/or sensor data received from other autonomous vehicles passing the geospatial location of this discrepancy. For example, the computer system can “average” discrepancy types associated with a group of discrepancy flags labeled with similar geospatial locations or execute a separate discrepancy classifier to (re)classify the discrepancy based on sensor data received from these autonomous vehicles. The computer system can additionally or alternatively interface with a human operator to confirm discrepancies and discrepancies types, such as by serving sensor data—labeled with geospatial discrepancy flags—to an operator portal for manual labeling.

### 8.3 Selective Sensor Data Collection

The computer system can also selectively query autonomous vehicles for raw or compressed sensor data representing a detected discrepancy via low(er)- and high(er)-bandwidth computer networks based on the characteristics of the discrepancy.

In one example, upon receiving a Type 1C discrepancy flag from an autonomous vehicle (or upon detecting a discrepancy that related to traffic flow nearby), the computer system can query this autonomous vehicle to return high-density (e.g., raw) sensor data—collected over a length of road preceding and succeeding the location of the Type 1C discrepancy—immediately via a low-bandwidth wireless network (e.g., a local cellular network). The computer system can then inject these sensor data into the global localization map in Block S120 in order to update the global localization map to represent this Type 1C discrepancy, as described below. The computer system can repeat this process with other autonomous vehicles passing the geospatial location of the discrepancy over a subsequent period of time until: the computer system converges on a 3D representation of the discrepancy and surrounding surfaces and objects in the global localization map; or until the Type 1C discrepancy is no longer detected.

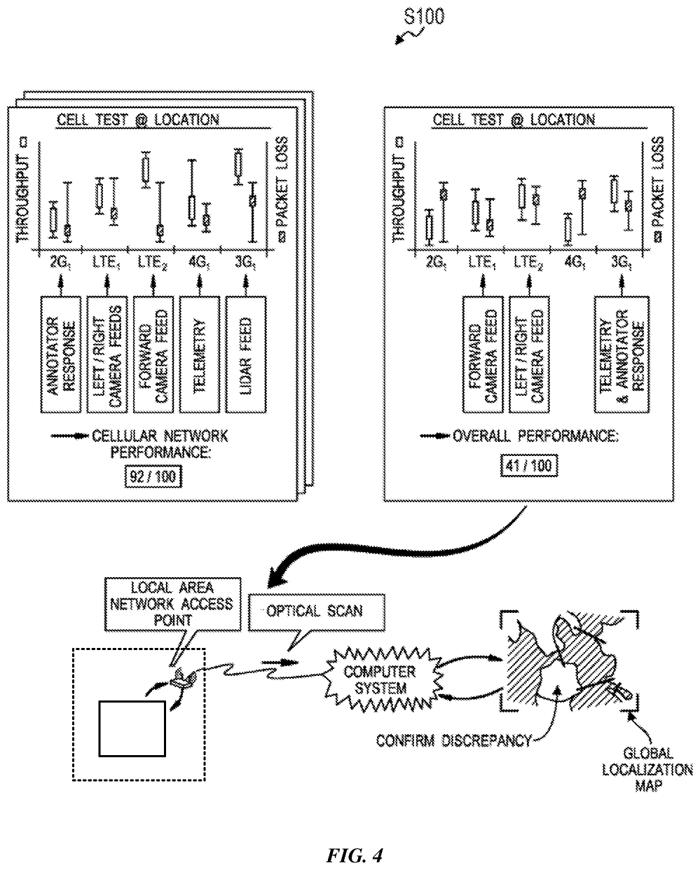

However, for a Type 1A or Type 1B discrepancy (or for a discrepancy not related to traffic flow nearby), the computer system can prompt autonomous vehicles that recently passed the geospatial location of this discrepancy to return high-density (e.g., raw) sensor data to the computer system only after connecting to high-bandwidth local area computer networks, such as wireless local area network access points at “home” locations assigned to the autonomous vehicles, as shown in FIGS. 2 and 4. The computer system can then implement methods and techniques described above to update the global localization map over time as these autonomous vehicles return these sensor data to the computer system over time.

For transient (i.e., impermanent) Type 1B discrepancies, the computer system can also: collect low-density (e.g., compressed) sensor data from these autonomous vehicles over a short period of time (e.g., minutes) following detection of such discrepancies via low-bandwidth wireless networks; generate localization map updates according to these compressed sensor data; and push temporary localization map updates—as well as prompts to maintain a local copy of the pre-update localization map—to autonomous vehicles nearby, as described above. The computer system can then trigger autonomous vehicles nearby to revert to local copies of pre-update localization maps when sensor data received from other autonomous vehicles passing the location of the discrepancy indicate that the discrepancy is no longer present (e.g., once an accident has been cleared).

However, the computer system can selectively retrieve raw or compressed sensor data from autonomous vehicles in the field according to any other schema and can interface with these autonomous vehicles in any other way to selectively update localization maps stored locally on these autonomous vehicles. The computer system can also repeat these processes over time, such as for multiple distinct discrepancies detected by a single autonomous vehicle during a single autonomous driving session.

### 9. Global Localization Map Update

Block S120 of the method S100 recites updating a first segment of a global localization map representing immutable surfaces proximal the first geospatial location based on the sensor data. Generally, in Block S120, the computer system can update the global localization map (e.g., one or more layers of the localization map) to reflect a confirmed discrepancy. For example, once the computer system confirms a discrepancy, the computer system can inject raw or compressed sensor data—corresponding to a discrepancy flag received from autonomous vehicles navigating past the discrepancy—into the global localization map thereby updating the global localization map to reflect this discrepancy.

In one implementation, the computer system implements computer vision, artificial intelligence, a convolution neural network, and/or other methods, techniques, or tools, to: characterize types of objects and surfaces represented in sensor data recorded near a geospatial location of a discrepancy (e.g., within a five-meter radius of a discrepancy); repopulate a small segment of the global localization map corresponding to this geospatial location with features (e.g., points) representing objects and surfaces detected in these sensor data; and to tag these features with their determined types and individual geospatial locations.

The computer system can also characterize a permanence of a discrepancy once confirmed, such as one of a permanent, semi-permanent, or transient change. For example, the computer system can characterize a resurfaced road section, lane addition, lane marker changes, and removal of trees near a road surface as permanent changes that may exist for months or years and then upload localization map updates for this discrepancy to substantially all autonomous vehicles assigned primary geographic regions containing the geospatial location of this discrepancy, both in real-time to autonomous vehicle en route to this geospatial location via a cellular network and asynchronously to other autonomous vehicles remote from this geospatial location via a local area network. In this example, the computer system can: also characterize presence of construction cones, construction vehicles, barrier changes (e.g., due to impact with a vehicle), and certain road sign changes (e.g., removal or damage), as semi-permanent changes that may exist for days or weeks; and selectively upload a localization map update reflecting this discrepancy to autonomous vehicles en-route to the discrepancy via a cellular network and to autonomous vehicles assigned routes that intersect the geospatial location of the discrepancy via a local area network, such as until autonomous vehicles passing this geospatial location no longer detect this discrepancy or until autonomous vehicles passing this geospatial location detect a different discrepancy (e.g., deviation from the original discrepancy). Furthermore, in this example, the computer system can: characterize traffic accidents and debris in the road as impermanent changes that may exist for minutes or hours; and selectively upload a localization map update reflecting this discrepancy to autonomous vehicles en route to the discrepancy via a cellular network until these autonomous vehicles no longer detect this discrepancy. Therefore, the computer system can track the state (i.e., the presence) of the discrepancy over time as additional autonomous vehicles pass the geospatial location of the discrepancy and return sensor data and/or discrepancy flags that do (or do not) indicate the same discrepancy and selectively push localization map updates to other autonomous vehicles in the geographic region accordingly over time.

In one variation, the computer system can also remotely analyze discrepancy flags and related sensor data received from one or more autonomous vehicles for a particular discrepancy in order to determine a best or preferred action for execution by autonomous vehicles approaching the discrepancy. For example, for the discrepancy that includes an overturned truck spanning multiple lanes of a highway (e.g., a “Type 1B” or “Type 1C” discrepancy), the computer system can calculate a local route for navigating around the overturned truck at a preferred (e.g., reduced) speed and at a preferred distance from the overturned truck. The computer system can then push definitions for this action—in additional to updated localization map data—to other autonomous vehicles currently navigating toward the geospatial location of this discrepancy, such as in (near) real-time via the low-bandwidth wireless network, as described above.

### 10. Local Localization Map Updates

Block S140 of the method S100 recites identifying a second vehicle currently executing a second route intersecting the first geospatial location and transmitting the first segment of the global localization map to the second vehicle—via the low-bandwidth wireless network—for incorporation into a second localization map stored locally on the second vehicle in (near) real-time; and Block S142 of the method S100 recites identifying a third vehicle operating within a geographic region containing the first geospatial location and executing a third route remote from the first geospatial location and transmitting the first segment of the global localization map to the third vehicle—via a high-bandwidth computer network—for incorporation into a third localization map stored locally on the third vehicle in response to the third vehicle connecting to the high-bandwidth computer network at a later time succeeding initial detection of the discrepancy. Generally, once the computer system confirms a discrepancy, the computer system can selectively push localization map updates to other autonomous vehicles in the field in Blocks S140 and S142, as shown in FIGS. 1 and 3.

### 10.1 Type 1C Discrepancies

In one implementation shown in FIGS. 1 and 3, the computer system monitors locations of other autonomous vehicles and routes currently executed by these autonomous vehicles. When the computer system confirms a Type 1C discrepancy (e.g., a large traffic accident), the computer system: identifies a subset of these autonomous vehicles that are moving toward or are currently executing routes that intersect or fall near the location of the discrepancy; and pushes localization map updates and preferred action definitions to these autonomous vehicles substantially in real-time over the low-bandwidth wireless network, thereby empowering these autonomous vehicles to detect this Type 1C discrepancy more rapidly and to respond to this Type 1C discrepancy according to an action selected by the computer system. These autonomous vehicles can also store this action definition—associated with attributes of the Type 1C discrepancy—and implement similar actions in the future autonomously if other discrepancies with similar attributes are detected; the computer system can therefore selectively and intermittently push discrepancy and action data to autonomous vehicles to assist these autonomous vehicles in preparing for immediate Type 1C discrepancies while also provisioning these autonomous vehicles with information for handling similar events in the future.

Furthermore, if the computer system characterizes a Type 1C discrepancy as transient, the computer system can push the localization map update and action definitions: to autonomous vehicles currently en route toward the discrepancy via a low-bandwidth wireless network (e.g., a cellular network); and to autonomous vehicles about to embark on routes that intersect the location of the discrepancy, such as via the highest-bandwidth wireless network available (e.g., cellular or Wi-Fi). Once the transient Type 1C discrepancy is confirmed as removed by autonomous vehicles passing this region (e.g., via new discrepancy flags indicating that the previous Type 1C discrepancy is not occurring where predicted by the updated localization map), the computer system can cease distributing these localization map updates and action definitions to autonomous vehicles and instead prompt these autonomous vehicles to resort to previous localization map content at the location of this transient Type 1C discrepancy.

However, if the computer system characterizes a Type 1C discrepancy as permanent or semi-permanent, the computer system can also push a localization map update and action definition for this discrepancy to (substantially) all autonomous vehicles associated with primary geographic regions containing the geospatial location of this discrepancy—in addition to uploading this content to autonomous vehicles en route toward this location. In particular, the computer system can: push this content to autonomous vehicles en route toward the location of the Type 1C discrepancy over a low-bandwidth wireless network substantially in real-time; and push this content to other autonomous vehicles—associated with primary geographic regions containing the location of the discrepancy—over high-bandwidth wireless networks when these other autonomous vehicles connect to these networks (e.g., when parked at home).

### 10.2 Type 1B Discrepancies

Similarly, when the computer system confirms a Type 1B discrepancy (e.g., a lane closure, small accident, pothole, or road resurfacing), the computer system: identifies a subset of autonomous vehicles that are moving toward or are currently executing routes that intersect or fall near the location of the discrepancy; and pushes localization map updates to these autonomous vehicles substantially in real-time over the low-bandwidth wireless network, thereby empowering these autonomous vehicles to detect this Type 1B discrepancy more rapidly. These autonomous vehicles can then implement onboard models for handling (e.g., avoiding) this Type 1B discrepancy when approaching and passing this discrepancy in the near future. The computer system can thus inform autonomous vehicles moving toward a Type 1B or Type 1C discrepancy of this discrepancy, thereby enabling these autonomous vehicles to both calculate their locations with a greater degree of confidence based on the known location of the discrepancy and to adjust navigational actions according to this discrepancy.

The computer system can thus ensure that (substantially all) autonomous vehicles heading toward and eventually passing through a road region in which a change at the road surface has been detected (e.g., Type 1B ad Type 1C discrepancies) are rapidly informed of this change once this change is detected (and confirmed), thereby enabling these autonomous vehicles to anticipate the change and to execute decisions at greater confidence intervals given better context for the current state of the road surface in this road region, as indicated by the localization map.

The computer system can implement methods and techniques similar to those described above to selectively distribute localization map updates to autonomous vehicles in real-time via low-bandwidth wireless networks and asynchronously via high-bandwidth wireless networks based on the determined permanence of the discrepancy. The computer system can also cease distributing localization map updates for Type 1B discrepancies once these discrepancies can be removed or returned to a previous state, as described above.

### 10.3 Type 1A Discrepancies

However, when the computer system confirms a Type 1A discrepancy (e.g., a new or fallen road sign, a fallen or trimmed tree), the computer system: identifies a set of autonomous vehicles associated with primary geographic regions that contain the location of discrepancy; and pushes localization map updates to these autonomous vehicles over high-bandwidth wireless networks once these vehicles are parked at home and connected to such networks, as shown in FIG. 3. The computer system can thus push localization map updates to autonomous vehicle at times when cost of such data transmission is relatively low, thereby enabling these autonomous vehicles to calculate their real locations and orientations from their localization maps with a greater degree of confidence when approaching and passing the location of the Type 1A discrepancy in the future.

Furthermore, in this implementation, the computer system can push localization map updates for Type 1A discrepancies to autonomous vehicles only for permanent and semi-permanent discrepancies and otherwise discard Type 1A discrepancies.

### 10.4 Selective Localization Map Updates and Autonomous Vehicle Rerouting

In one variation shown in FIG. 3, after receiving a discrepancy flag and sensor data from an autonomous vehicle, verifying a discrepancy, and updating a corresponding segment of the global localization map accordingly, such as described above, the computer system can: query an autonomous vehicle fleet manager for autonomous vehicles currently near the geospatial location of the discrepancy and/or executing routes approximately intersecting this geospatial location and then selectively distribute the localization map update to these autonomous vehicles. In one implementation, the computer system: queries an autonomous vehicle fleet manager for a first list of autonomous vehicles currently autonomously executing rideshare routes that fall within a threshold distance (e.g., fifty meters) of the first geospatial location and currently approaching the first geospatial location of the discrepancy; and then transmits the localization map update (e.g., the segment of the global localization map representing the detected discrepancy) to each autonomous vehicle in this first set of autonomous vehicles via a local cellular network within wireless range of the geospatial location of the discrepancy.

Alternatively, the computer system can: isolate a first subset of autonomous vehicles—in this first list of autonomous vehicles—that are within a threshold distance (e.g., within one mile) of the geospatial location of the discrepancy, within a threshold time (e.g., five minutes) of this geospatial location, or currently executing routes through this geospatial location but with limited options for rerouting around the discrepancy; and selectively upload the localization map update to each autonomous vehicle in this first subset in (near) real-time via a local cellular network within wireless range of this geospatial location. The computer system (or the autonomous vehicle fleet manager) can therefore push a localization map update to autonomous vehicles approaching the geospatial location of the discrepancy via a low-bandwidth, higher-cost wireless (e.g., cellular) network.

In this implementation, the computer system can also identify a second subset of autonomous vehicles—in this first list of autonomous vehicles—outside of the threshold distance of the geospatial location of the discrepancy, outside of the threshold time of this geospatial location, or currently executing routes through this geospatial location and with at least one option for rerouting around the discrepancy. For a particular autonomous vehicle in this second subset, the computer system (or the autonomous vehicle fleet manager) can: update a particular route currently executed by the particular autonomous vehicle to circumvent the geospatial location of the discrepancy; and later transmit the localization map update to the particular autonomous vehicle—via a high-bandwidth computer network—for incorporation into a localization map stored locally on the particular autonomous vehicle in response to the particular autonomous vehicle connecting to this high-bandwidth computer network at a later time, as shown in FIG. 3. For the particular autonomous vehicle, the computer system (or the autonomous vehicle fleet manager) can alternatively: update the particular route currently executed by the particular autonomous vehicle to incorporate a layover at a second geospatial location within wireless range of a high-bandwidth wireless local area network access point, such as a wireless-enabled charging station or refueling station between the particular autonomous vehicle's current location and the geospatial location of the discrepancy; transmit the localization map update to the particular autonomous vehicle—via a high-bandwidth wireless local area network access point located at the layover location—in response to the particular autonomous vehicle arriving at the layover and wirelessly connecting to the high-bandwidth wireless local area network access point; and then dispatch the particular autonomous vehicle to resume its particular route through the first geospatial location of the discrepancy after the particular autonomous vehicle loads the localization map update and incorporates the localization map update into a local copy of the global localization map stored on the particular autonomous vehicle. The computer system can repeat this process for each other autonomous vehicle in the second subset of autonomous vehicles currently en route to the geospatial location of the discrepancy. The computer system (or the autonomous vehicle fleet manager) can therefore reroute an autonomous vehicle approaching the geospatial location of the discrepancy to avoid the discrepancy altogether or to access a high-bandwidth local area network through which to download a localization map update.

In this implementation, the computer system can additionally or alternatively query a cellular network quality database (e.g., in the form of a map) for cellular network quality (e.g., bandwidth, download speed) proximal the geospatial location of the discrepancy and/or query autonomous vehicles in the first list of autonomous vehicles directly for cellular network qualities in their current locations. The computer system (or the autonomous vehicle fleet manager) can then: identify a particular autonomous vehicle, in the first list of autonomous vehicles, currently occupying a particular geospatial location with historically poor cellular network quality or currently within wireless range of a cellular network characterized by less than a threshold quality (e.g., insufficient bandwidth or download speed); and update a route currently executed by the particular autonomous vehicle to intersect a second geospatial location—between the current geospatial location of the particular autonomous vehicle and the geospatial location of the discrepancy—associated with an historical cellular network quality that exceeds the threshold quality (e.g., is historically characterized by higher bandwidth or download speed). The computer system can then transmit the localization map update to the particular vehicle via the low-bandwidth wireless network when the second vehicle approaches or reaches the second geospatial location, as shown in FIG. 4. The computer system (or the autonomous vehicle fleet manager) can therefore reroute an autonomous vehicle approaching the geospatial location of the discrepancy to access a higher-quality cellular network. The computer system can also implement the foregoing methods and techniques for each other autonomous vehicle in the first subset, the second subset, of the first list generally.

In this implementation, the computer system can additionally or alternatively: rank autonomous vehicles in the first list of autonomous vehicles, such as inversely proportional to estimated time of arrival at or distance to the geospatial location of the discrepancy; and then serially upload the localization map update to autonomous vehicles in the first list via the low-bandwidth wireless network according to this rank. By thus serially uploading localization map updates to these autonomous vehicles approaching the geospatial location of the discrepancy via a local wireless network, the computer system can limit load on the local wireless network at any one time and better ensure that the localization map update timely reaches these autonomous vehicles.

In this implementation, the computer system can also: query the autonomous vehicle fleet manager for a second list of autonomous vehicles currently commissioned to the geographic region containing the geospatial location of the discrepancy but currently parked or currently executing rideshare routes disjoint (e.g., offset by more than fifty meters) from the geospatial location of the discrepancy; and flag each autonomous vehicle in this second list. For each autonomous vehicle on this second list, the computer system can: selectively transmit the localization map update to the autonomous vehicle via a high-bandwidth computer network when the autonomous vehicle next connects to a local area network access point, as shown in FIG. 3; or selectively transmit the localization map update to the autonomous vehicle via a low-bandwidth cellular network when a route intersecting the geospatial location of the discrepancy is later assigned to the autonomous vehicle; whichever is earlier. For example, the computer system can: transmit the localization map update to a second autonomous vehicle—via the low-bandwidth wireless network—within five minutes of a first autonomous vehicle first detecting this discrepancy; and transmit the localization map update to a third autonomous vehicle—via the high-bandwidth computer network—at least two hours after the first autonomous vehicle first detects this discrepancy.

However, the computer system can implement any other method or technique to selectively transmit localization map updates to the autonomous vehicles operating within a geographic region. The computer system can implement similar methods and techniques: to generate navigation map updates to reflect changes in roadways, lane markers, traffic signals, and/or road signs, etc. detected by autonomous vehicles operating within this geographic region; and to selectively distribute navigation map updates to these autonomous vehicles in order to enable these autonomous vehicles to anticipate these changes and to elect and execute autonomous navigational actions accordingly.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, a cloud server, or any other suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

What is claimed is:

1. One or more tangible non-transitory computer-readable storage media storing computer-executable instructions for performing a computer process on a computing system, the computer process comprising:
receiving a discrepancy flag associated with a particular geographic location from a vehicle operating in a geographic region over a network, the discrepancy flag generated based on a comparison of a local localization map of the vehicle with scan data for a field of view of at least one sensor of the vehicle;
receiving the scan data from the vehicle over the network;
updating a segment of a global localization map corresponding to the discrepancy flag using the scan data;
identifying a plurality of vehicles operating in the geographic region; and
selectively pushing the segment of the global localization map to the plurality of vehicles based on a network connectivity of each of the plurality of vehicles and a location of each of the plurality of vehicles within the geographic region.

2. The one or more tangible non-transitory computer-readable storage media of claim 1, further comprising:
identifying a first subset of the plurality of vehicles having at least one of a proximity to the particular geographic location or a planned route intersecting the particular geographic location, the segment of the global localization map pushed to the first subset of the plurality of vehicles at a first time, the segment of the globalization pushed to a second subset of the plurality of vehicles at a second time later than the first time.

3. The one or more tangible non-transitory computer-readable storage media of claim 2, wherein the segment of the global localization map is pushed to the first subset of the plurality of vehicles via a first network bandwidth and to the second subset of the plurality of vehicles at a second network bandwidth, the second network bandwidth being higher than the first network bandwidth.

4. The one or more tangible non-transitory computer-readable storage media of claim 1, wherein the segment of the global localization map is selectively pushed to a first subset of the plurality of vehicles synchronously and a second subset of the plurality of vehicles asynchronously.

5. The one or more tangible non-transitory computer-readable storage media of claim 1, wherein the segment of the global localization map is further selectively pushed based on a discrepancy type of the discrepancy flag.

6. The one or more tangible non-transitory computer-readable storage media of claim 5, wherein the discrepancy type includes at least one of traffic flow related, localization related, transient, or permanent.

7. The one or more tangible non-transitory computer-readable storage media of claim 1, wherein the comparison of the local localization map of the vehicle with the scan data includes an alignment of a constellation of real features in the field of view of the vehicle detected in the scan data with a constellation of georeferenced features represented in the local localization map, the discrepancy flag being generated based on one or more discrepancies in the alignment.

8. The one or more tangible non-transitory computer-readable storage media of claim 1, wherein the plurality of vehicles are identified by querying a fleet manager for a list of vehicles operating in the geographic region.

9. The one or more tangible non-transitory computer-readable storage media of claim 8, wherein the list of vehicles includes a first list including one or more first vehicles operating within a threshold distance of the particular geographic location and a second list include one or more second vehicles within the geographic region outside the threshold distance.

10. The one or more tangible non-transitory computer-readable storage media of claim 9, wherein the first list includes a ranking of the one or more first vehicles determined based on an estimated time of arrival at the particular geographic location, the segment of the global localization map being selectively pushed to the one or more first vehicles based on the ranking.

11. A method for localization, the method comprising:
receiving a discrepancy flag associated with a particular geographic location from a vehicle operation in a geographic region over a network, the discrepancy flag generated based on a detection of at least one discrepancy between a local localization map of the vehicle and scan data for a field of view of at least one sensor of the vehicle;
receiving the scan data from the vehicle over the network;
updating a segment of a global localization map corresponding to the discrepancy flag using the scan data;
identifying a plurality of vehicles associated with the geographic region;
identifying a first subset of the plurality of vehicles based on the particular geographic location; and
selectively pushing the segment of the global localization map to the plurality of vehicles based on a location of each of the plurality of vehicles within the geographic region, the first subset of the plurality of vehicles receiving the segment of the global localization map at a first time and a second subset of the plurality of vehicles receiving the segment of the global localization map at a second time later than the first time.

12. The method of claim 11, wherein the first subset of the plurality of vehicles is identified based on at least one of a proximity to the particular geographic location or a planned route intersecting the particular geographic location.

13. The method of claim 11, wherein the first subset of the plurality of vehicles is identified based on a threshold distance from the particular geographic location.

14. The method of claim 11, wherein the detection of the at least one discrepancy is based on an alignment of a constellation of real features in the field of view of the vehicle detected in the scan data with a constellation of georeferenced features represented in the local localization map.

15. The method of claim 11, wherein the segment of the global localization map is further selectively pushed based on a discrepancy type of the discrepancy flag.

16. The method of claim 15, wherein the discrepancy type includes at least one of traffic flow related, localization related, transient, or permanent.

17. A system for localization, the system comprising:
at least one sensor of a vehicle capturing scan data for a field of view,
memory of the vehicle storing a local localization map for a geographic region; and
at least one processor generating a discrepancy flag associated with a particular geographic location based on a detection of at least one discrepancy between the local localization map of the vehicle and scan data for the field of view of the at least one sensor of the vehicle, the discrepancy flag and the scan data being selectively transmitted to a computing device over a network based on a network connectivity of the vehicle and a discrepancy type of the at least one discrepancy.

18. The system of claim 17, wherein the detection of the at least one discrepancy is based on an alignment of a constellation of real features in the field of view of the vehicle detected in the scan data with a constellation of georeferenced features represented in the local localization map.

19. The system of claim 17, wherein the discrepancy flag and the scan data is selectively transmitted to the computing device for updating a segment of a global localization map corresponding to the discrepancy flag using the scan data.

20. The system of claim 17, wherein the discrepancy type includes at least one of traffic flow related, localization related, transient, or permanent.
